(19) United States
(12) Patent Application Publication
(10) Pub. No.: US 2016/0012383 A1
(43) Pub. Date: Jan. 14, 2016

(54) IMPACT OF UNPLANNED LEAVES ON PROJECT COST

(71) Applicant: Oracle International Corporation, Redwood Shores, CA (US)

(72) Inventors: Vaibhav APARIMIT, Bangalore (IN); Manish KUMAR, Bangalore (IN); Raghavan SRINIVASAN, Bangalore (IN)

(21) Appl. No.: 14/326,538

(22) Filed: Jul. 9, 2014

(51) Int. Cl. G06Q 10/06

(52) U.S. Cl. CPC G06Q 10/063118; G06Q 10/06375; G06Q 10/0635

(57) ABSTRACT

An unplanned leave manager is provided that predicts the impact of unplanned leaves on a project. Historical unplanned leave data corresponding to one or more project team members is provided. The manager determines, for each of the project team members, a mean time between unplanned leaves and a rate of unplanned leaves based on the member's corresponding historical unplanned leave data. The manager predicts a cost impact of future unplanned leaves of the project team members, based on at least one of: the mean time between unplanned leaves; and the rate of unplanned leave. The manager selects one or more of the project team members based, at least in part, on at least one of: the determined mean time between unplanned leaves; the determined rate of unplanned leaves; or the predicted cost impact. The manager then staffs the project with the selected members.

### FIELD

One embodiment is directed generally to a computer system, and in particular to a computer system for project management.

### BACKGROUND INFORMATION

Project management is the process and activity of planning, organizing, motivating, and controlling resources, procedures and protocols to achieve specific goals in scientific or daily problems. A project is a temporary endeavor designed to produce a unique product, service or result with a defined beginning and end (usually time-constrained, and often constrained by funding or deliverables), undertaken to meet unique goals and objectives, typically to bring about beneficial change or added value. The temporary nature of projects stands in contrast with business as usual (or operations), which are repetitive, permanent, or semi-permanent functional activities to produce products or services.

A project's planned cost compliance is contingent on availability of project team members. Information regarding planned leaves of project team members which include weekends off, national holidays, regional holidays, corporate holidays and any other expected holidays during a project's timeline can be captured in a project calendar or a resource calendar. These calendars can be used as inputs by a project planner to compute a project's schedule and costs.

However, in actuality project team members can take unplanned leaves for a variety of reasons like ill-health or attending any personal emergency or taking off for holiday season and festivals. Such unplanned/unexpected leaves can have a tangible impact on a project's cost and/or schedule.

### SUMMARY

One embodiment is a system that predicts the impact of unplanned leaves on a project. The system provides historical unplanned leave data corresponding to one or more project team members. The system determines, for each of the project team members, a mean time between unplanned leaves and a rate of unplanned leaves based on the member's corresponding historical unplanned leave data. The system predicts a cost impact of future unplanned leaves of the project team members, based on at least one of: the mean time between unplanned leaves; and the rate of unplanned leave. The system selects one or more of the project team members based, at least in part, on at least one of: the determined mean time between unplanned leaves; the determined rate of unplanned leaves; or the predicted cost impact. The system then staffs the project with the selected members.

### BRIEF DESCRIPTION OF THE DRAWINGS

FIG. 1 is a block diagram of a computer system that can implement an embodiment of the present invention.

FIG. 2 is a flow diagram showing the functionality for determining the impact of unplanned leaves on project cost and/or schedule in accordance with one embodiment.

FIG. 3 is a table including Rate of Unplanned Leaves (“RUL”) metrics and replacement cost values for each member of a project team in accordance with one embodiment.

FIG. 4 is a table of a probability (“Pi”) and cost impact (“Pi*Ci”) of each team member taking exactly n leaves, where n=1, 2, 3, 4, or 5, in accordance with one embodiment.

FIG. 5 is a table illustrating the probability and cost impact for exactly n unplanned leaves by all project team members, where n=1, 2, 3, 4, or 5, in accordance with one embodiment.

FIG. 6 illustrates a graph of the probability of taking exactly n unplanned leaves by all project team members, where n=1, 2, 3, 4, or 5, in accordance with one embodiment.

FIG. 7 illustrates a graph of the variation of cost impact when all project team members take exactly n unplanned leaves, where n=1, 2, 3, 4, or 5, in accordance with one embodiment.

FIG. 8 illustrates a graph of variation of cost impact with the log of probability, of taking exactly n unplanned leaves, where n=1, 2, 3, 4, or 5, in accordance with one embodiment.

### DETAILED DESCRIPTION

One embodiment is a system that predicts the impact of unplanned leaves on a project. The system can provide historical unplanned leave data corresponding to one or more project team members. The system can determine, for each of the one or more project team members, a mean time between unplanned leaves and a rate of unplanned leaves based on the member's corresponding historical unplanned leave data. The system can predict a cost impact of future unplanned leaves of the one or more project team members, based on at least one of: the mean time between unplanned leaves; and the rate of unplanned leave. The system can then select one or more of the one or more project team members, and then can staff the project with the selected members. In some embodiments, the selection can be a user selection, or the system can automatically perform the selection based on the predicted cost impact.

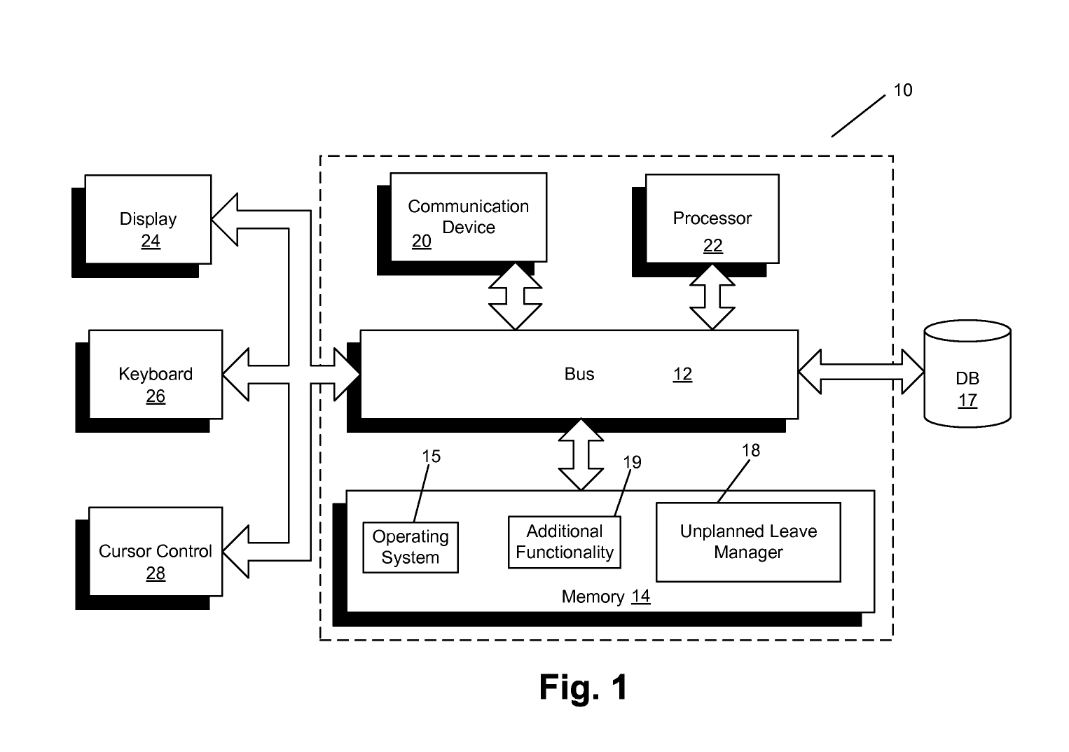

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include an unplanned leave manager 18 that determines the impact of unplanned leaves of project members, as disclosed in more detail below. System 10 can be part of a larger system, such as an enterprise resource planning (“ERP”) system, or a project planner, such as “Primavera Project Portfolio Management” from Oracle Corp. Therefore, system 10 will typically include one or more additional functional modules 19 to include the additional functionality. A database 17 is coupled to bus 12 to provide centralized storage for modules 18 and 19 and store project management information, resource information, etc.

In one embodiment, system 10 provides historical unplanned leave data for prospective project team members and determines a cost impact of future unplanned leaves of the prospective project team members based on the historical data. In some embodiments, system 10 displays a graphical representation of the cost impact of such unplanned leaves on a display such as, for example, display 24, so that a user (e.g., a project planner) can quickly and easily compare the prospective project team members by viewing the graphical representation and select those prospective project team members that are desired to staff the project team. In some embodiments, system 10 can recommend project team members to be selected by the user or system 10 can automatically select project team members based on the cost impact.

A “project team” can include a collection of individuals in an organization who work interdependently towards achieving common and shared goals of a project. Project teams can be divided into sub teams and are only used during a definite period of time. They are disbanded after the project goals are achieved.

A “project planner” can be part of the project management organization, can be responsible for scheduling tasks in a project, and can also be responsible for subsequently reporting progress within the project environment.

A “project calendar” can include a list of holidays, vacations and/or other non-work time period for a project.

A “resource calendar” can include a list of holidays, vacations and/or other non-work time period for a resource (e.g., a team member). The project calendar, in conjunction with the resource calendar, can be used by the project planner to create a project schedule (e.g., a baseline project schedule).

“Unplanned leaves” of team members can include any vacations taken or applied for after a baseline project schedule and cost has already been prepared. Unplanned leaves do not include public holidays, regional holidays, company mandated annual vacations or any other leave that was included in the resource calendar when the baseline project schedule was created.

Mean time between failures (“MTBF”) is the predicted elapsed time between inherent failures of a system during operation. MTBF can be calculated as the arithmetic mean (i.e., average) time between failures of a system:

$$Mean time between failures = MTBF = \frac{\sum ( start of downtime - start of uptime )}{number of failures} . \\$$

A Poisson distribution is a discrete distribution. The Poisson distribution is often used as a model for the number of events (such as the number of telephone calls at a business, number of customers in waiting lines, number of defects in a given surface area, airplane arrivals, or the number of accidents at an intersection) in a specific time period. The Poisson distribution is also useful in ecological studies (e.g., to model the number of prairie dogs found in a square mile of prairie). The Poisson distribution can be calculated, where the mean is λ and the variance is λ, by:

$$p ( x , λ ) = \frac{{e}^{- λ} {λ}^{e}}{xl} for x = 0 , 1 , 2 , … .$$

Where λ is the parameter which indicates the average number of events in the given time interval.

The definition of MTBF depends on the definition of what is considered a system failure. For complex, repairable systems, failures are considered to be those “out-of-design” conditions which place the system out of service and into a state for repair. Failures which occur that can be left or maintained in an unrepaired condition, and do not place the system out of service, are not considered failures under this definition of MTBF.

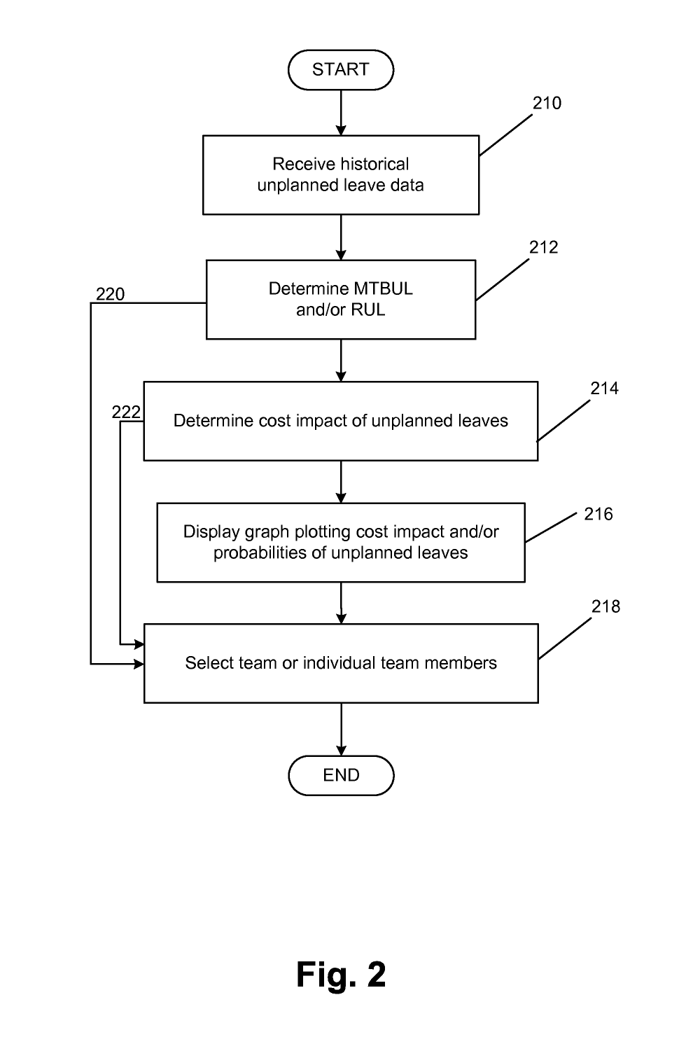

FIG. 2 is a flow diagram showing the functionality for determining the impact of unplanned leaves on project cost and/or schedule in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 210, historical unplanned leave data is received from a database or some other computer system. Project and resource calendars can also be received.

At 212, module 18 determines a Mean Time Between Unplanned Leaves (“MTBUL”) metric representing the extent to which a project team member takes unplanned leaves. MTBUL is the difference of total working time and total period elapsed during unplanned leaves for one team member divided by the number of unplanned leaves. Working time and unplanned leaves can be represented in days. Working times can exclude include weekends, public holidays, and/or any other organizational level mandated time-offs. Working time can include actual planned billable time of the team member. MTBUL can be defined as:

MTBUL=(Σ(work periods in days)−Σ(period elapsed during unplanned leaves))/(number of unplanned leaves).

MTBUL calculations can be performed for any time period (e.g., for 6 months, 1 year, 2 years etc.), and the unit of MTBUL can be days per unplanned leave. For example, a project team member who has to work from May 1^{st}-May 31^{st} can have a 7 day work (or project) calendar, with no public holidays or any other organizational mandated time off in the month of May (e.g., no other holidays/time off in the project calendar). In such an example, if the project team member takes two unplanned vacations, the first unplanned vacation being from 5^{th} May to 10^{th} May and the second one being from 25^{th} May to 28^{th} May, MTBUL is determined according to the following:
Σ(work periods in days)=days in the month of May=31 days;
Σ(period elapsed during unplanned leaves)=(May 10^{th}-May 5^{th})+(May 28^{th}-May 25^{th})=6+4=10 days;
Number of unplanned leaves or vacations=2;
And therefore, MTBUL=(31−10)/2=10.5 days.

Module 18 can also determine, based on the MTBUL, a Rate of Unplanned Leaves (“RUL”). The Rate of Unplanned Leaves or RUL for given time horizon for a project team member is defined as the inverse of MTBUL for the same project team member and therefore RUL can be defined as:

RUL=1/MTBUL.

The units of RUL is number of unplanned leaves per day. In the example discussed above, RUL=1/10.5=0.095 leaves per day.

Module 18 can determine MTBUL and RUL for one or more entire project teams. For a project team with n members let {MTBUL₁, RUL₁}, {MTBUL₂, RUL₂}, {MTBUL₃, RUL₃}, . . . , {MTBULₙ, RULₙ} be the ordered set of MTBUL and RUL for the team member 1, team member 2, team member 3, . . . , team member n, respectively, such that:
MTBULᵢ=1/RULᵢ for iε{1, 2, . . . , n};
the project team's RUL=ΣRULᵢ, ∀iε{1, 2, . . . , n}; and
the project team's MTBUL=Σ(1/RULᵢ), ∀iε{1, 2, . . . , n}.

At 214, module 18 determines the cost impact of unplanned leaves. The cost impact can be determined based on, for example, the MTBUL and the RUL metrics. For example, a project team or a team member with high MTBUL is more reliable with low chances of taking unplanned leaves. Consequently, high MTBUL is correlated with low cost impact and vice versa. In some embodiments, a project team with overall highest MTBUL can be recommended and/or automatically selected, with all other attributes of project teams remaining substantially the same.

The expected cost impact of unplanned leaves of team members 1-n (i.e., “CI”), can be defined based on MTBUL, as follows:
CI=ΣCᵢ*Dᵢ/MTBULᵢ ∀iε{1, 2, . . . , n}=cost impact for all team members;
Where Dᵢ is the number of days of working period of team member i in the project;
MTBULᵢ is the MTBUL for team member i; and
Cᵢ is the cost of replacement of team member i. Cᵢ includes the search cost of finding a new replacement, cost of delay in finding a replacement and cost of learning systems, processes, team dynamic etc. of the new team member and the incremental extra cost of hiring/contracting a new project team member on short notice.

The expected cost impact of unplanned leaves of team members 1-n, can, alternatively or additionally, be determined based on RUL and Poisson distribution. Poisson distribution can be used to ascertain the probabilities of exactly n unplanned leaves. λ can be the RUL of a team member in a given period of time. The probability of exactly n unplanned leaves during the same time period can be given by P(x=n; λ)=(e^{-λ}*λⁿ)/n!.

For example, the probability of exactly zero unplanned leaves in 260 days where RUL is once every 260 days is given by:

P(x=0;1)=(e⁻¹*1⁰)/0!=0.3679.

The probability of exactly one unplanned leave in 260 days where RUL is once every 260 days is given by:

P(x=1;1)=(e⁻¹*1¹)/1=0.3679.

The probability of exactly two unplanned leaves in 260 days where RUL is once every 260 days is given by:

P(x=2;1)=(e⁻¹*1²)/2!=0.1839.

The probability of two or fewer than two unplanned leaves can be given by:

P(x<=2;1)=P(x=0;1)+P(x=1;1)+P(x=2;1)=0.9197.

The cost impact of “exactly”, “fewer or equal”, “more or equal” and “more than n” unplanned leaves of a team member, in a project team of size K can be given by, CI=ΣCᵢ*Pᵢ, ∀iε{1, 2, . . . , K}, where:
Pᵢ=Probability of occurrence of an event associated with n leaves for the i^{th} team member. So Pᵢ may represent the probability of “exactly”, “fewer or equal”, “more or equal” and “more than n” unplanned leaves;
Cᵢ=replacement cost of a team member i, when team member i goes on an unplanned leave. Cᵢ includes the search cost of finding a new replacement, cost of delay in finding a replacement and cost of learning systems, processes, team dynamic etc. for the new team member and the incremental extra cost of hiring/contracting a new project team member; and
λᵢ=RUL of i^{th} team member.

For example, the cost impact for exactly n unplanned leaves for all team members, in a project team of size K can be given by:

CI=ΣCᵢ*P(x=n,λᵢ),∀iε{1,2, . . . ,K}.

The cost impact for n or fewer unplanned leaves for all team members, in a project team of size K can be given by:

CI=ΣCᵢ*P(x<=n,λᵢ),∀iε{1,2, . . . ,K}.

The cost impact for fewer than n unplanned leaves for all team members, in a project team of size K can be given by:

CI=ΣCᵢ*P(x<n,λᵢ),∀iε{1,2, . . . ,K}.

The cost impact for n or more unplanned leaves for all team members, in a project team of size K can be given by:

CI=ΣCᵢ*P(x>=n,λᵢ),∀iε{1,2, . . . ,K}.

The cost impact for more than n unplanned leaves for all team members, in a project team of size K can be given by:

CI=ΣCᵢ*P(x>n,λᵢ),∀iε{1,2, . . . ,K}.

At 216, module 18 can display a graph that includes a plot of cost impact against probability. For example, probability can be determined as follows:
Pᵢₙ=the probability of occurrence of an event associated with n leaves for the i^{th} team member in a K member project team;
Pᵢ may represent the probability of “exactly”, “fewer or equal”, “more or equal” and “more than n” unplanned leaves;
Pₙ=P₁ₙ*P₂ₙ*P₃ₙ* . . . *P_{Kn}=ΠPᵢₙ ∀iε{1, 2, . . . , K};
Pₙ can represent the probability of occurrence of an event associated with n unplanned leaves for the entire project team with K members and Pₙ may represent the probability of “exactly”, “fewer or equal”, “more or equal” and “more than n” unplanned leaves for all the members of the project team; and
CIₙ=the cost impact of “exactly”, “fewer or equal”, “more or equal” and “more than n” unplanned leaves of all project team members, in a project team of size K.

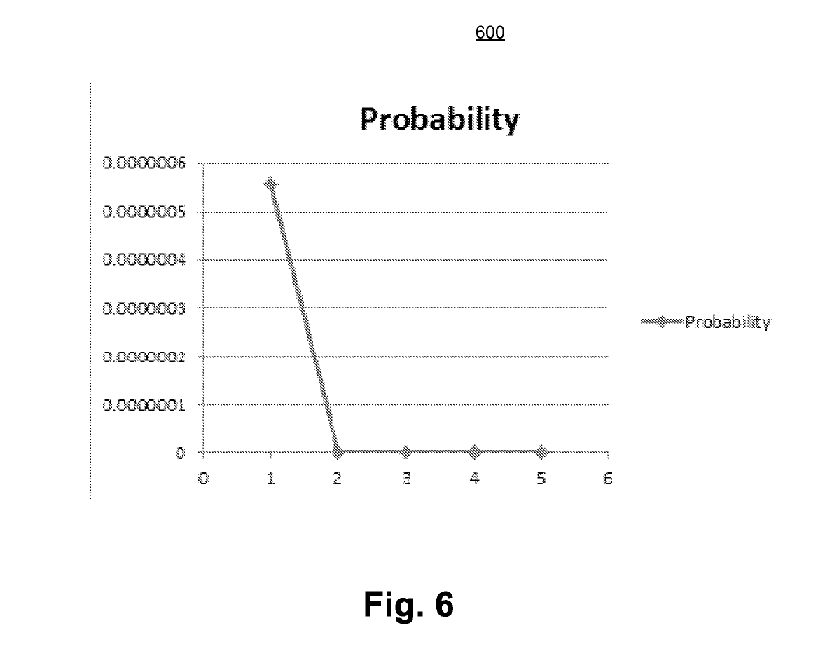

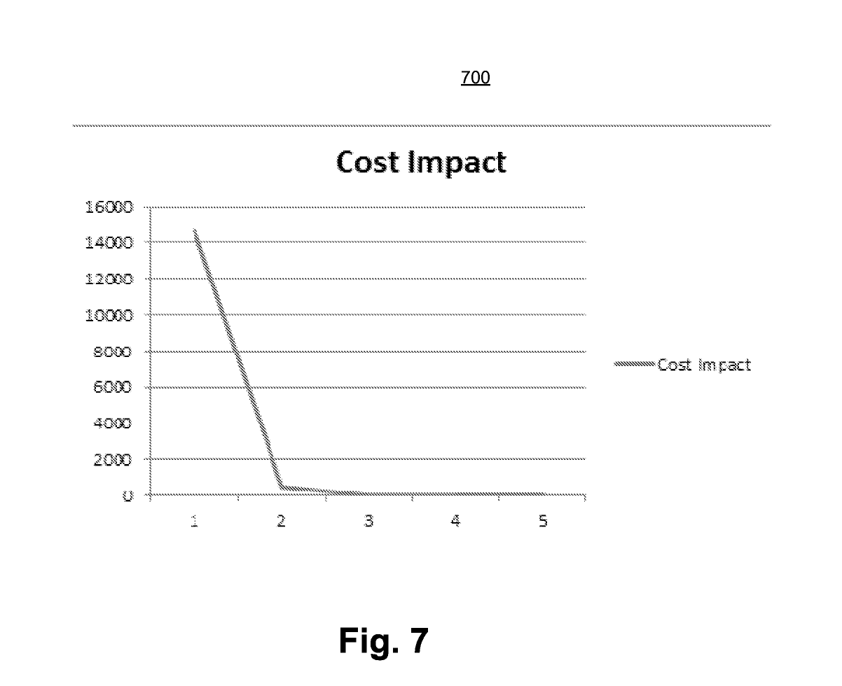

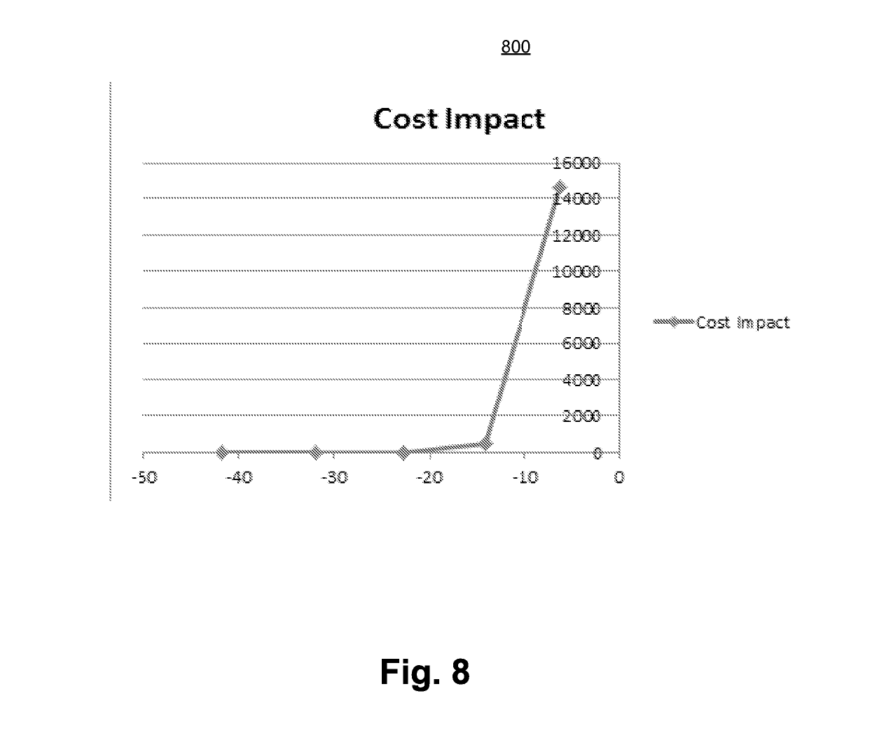

The set of (Pₙ, CI_{A}) can plotted on an X-Y 2D graph, for various values of n to generate a probability distribution for variation of cost impact in accordance with n. In some embodiments the graph can include the probabilities, as shown, for example, in graph 600 of FIG. 6 described below. In some embodiments the graph can include the cost impact, as shown, for example, in graphs 700 and 800 of FIGS. 7 and 8, respectively, and described below

In some embodiments, module 18 can display a graph of cost impact based only on MTBUL without determining the aforementioned probabilities.

In some embodiments, module 18 can display more than one project team on the graph. In such embodiments, the graph can provide a graphical comparison of the two project teams to facilitate user selection of one or more of the project teams. In some embodiments, the graph can display two or more individual project team members to provide a graphical comparison of the two or more individual project team members to facilitate user selection of one or more of the individual project team members included in the graph.

At 218, a project team or individual team members can be selected. In some embodiments, module 18 automatically selects or recommends a project team or a project team member based on the determined cost impact and/or the determined probability. In some embodiments, a user can select a project team member or an entire project team based on the graph displayed at 218 by module 18.

In some embodiments, after module 18 determines cost impact of unplanned leaves at 214, the user can manually select, or module 16 can be configured to automatically recommend or select a project team or individual team members, as shown by line 222.

In some embodiments, a project team or individual team members can be selected based on MTBUL and/or RUL metrics, without determining cost impact, as shown by line 220. In some such embodiments, although not shown, the MTBUL and/or RUL metrics can be graphed to facilitate user selection and/or recommendation by module 18.

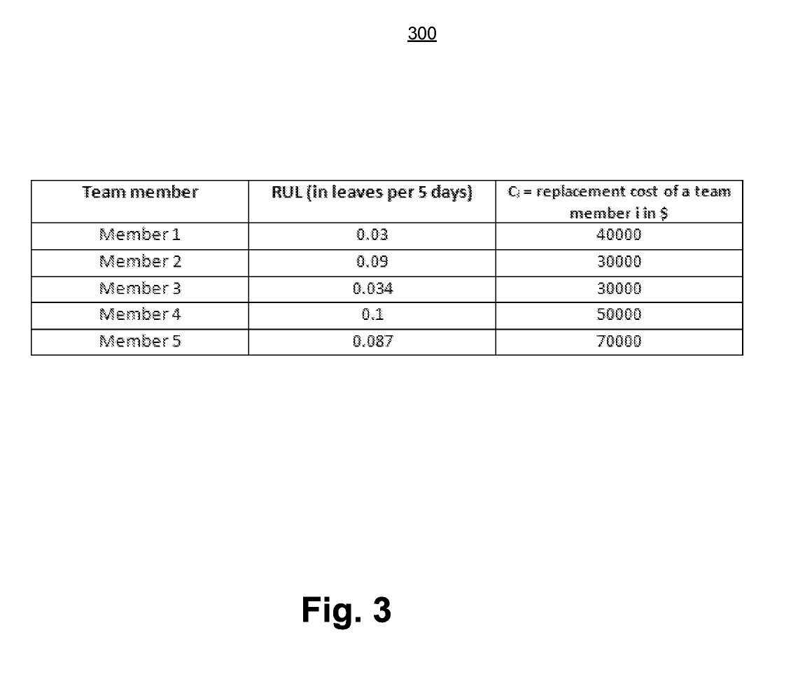

FIG. 3 is a table 300 including RUL metrics and replacement cost values for each member of a project team in accordance with one embodiment. Table 300 includes five members of a project team where the duration of the project is 5 days with no weekends and no public holidays. Any leave taken by a team member during project execution will fall under the ambit of unplanned leave. Using historical data about team members, RUL values can be determined as shown in table 300.

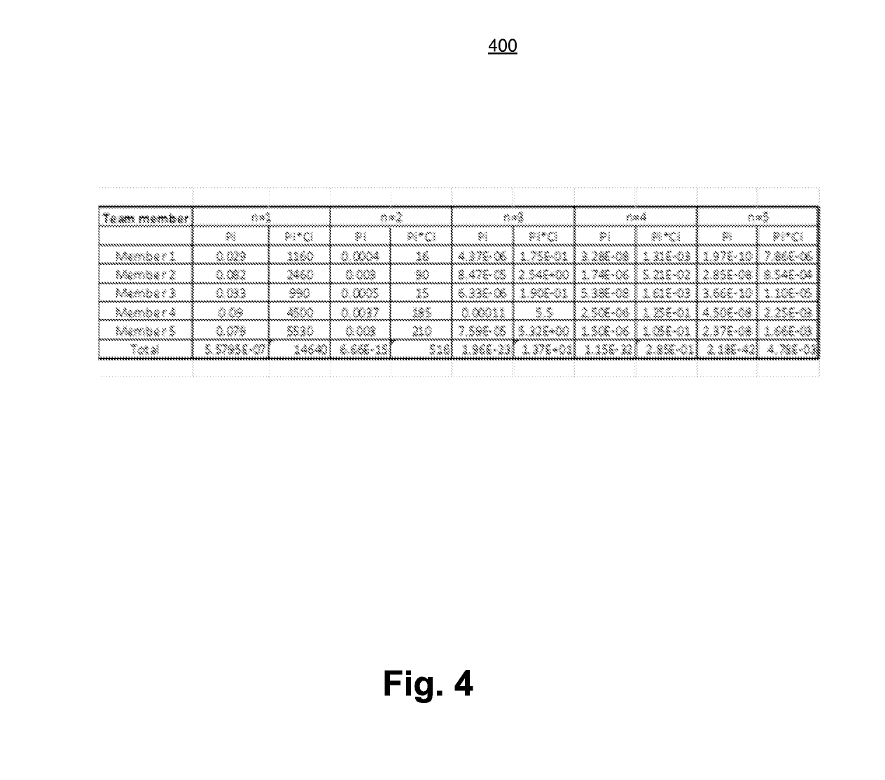

FIG. 4 is a table 400 of a probability (“Pi”) and cost impact (“Pi*Ci”) of each team member taking exactly n leaves, where n=1, 2, 3, 4, or 5, in accordance with one embodiment. The user (e.g., a project manager) may be interested in finding out the cost impact of team members taking exactly n leaves where n varies from 1-5. Table 400 shows the Poisson probability, Pi, and the cost impact, Pi*Ci, of each team member taking exactly n unplanned leaves where n varies from 1-5.

The last row of table 400 totals the probability and cost impact for all team members. When n=1, the probability that all team members take a 1-day unplanned vacation is specified by multiplying Pi for n=1. The overall cost impact is the summation of cost impacts of team members for a given n.

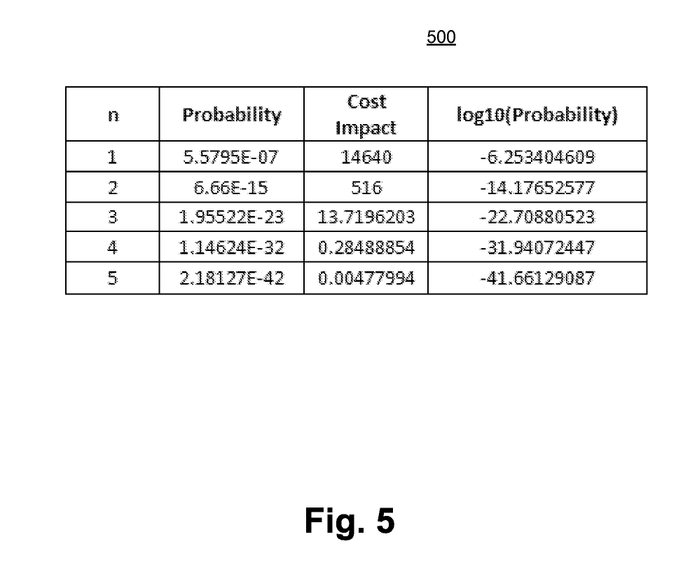

FIG. 5 is a table 500 illustrating the probability and cost impact for exactly n unplanned leaves by all project team members, where n=1, 2, 3, 4, or 5, in accordance with one embodiment.

FIG. 6 illustrates a graph 600 of the probability of taking exactly n unplanned leaves by all project team members, where n=1, 2, 3, 4, or 5, in accordance with one embodiment. As show in graph 600, the probability drops down to zero after n=1, which means that there is a very low chance that all the team members take unplanned leaves for more than 1 day.

FIG. 7 illustrates a graph 700 of the variation of cost impact when all project team members take exactly n unplanned leaves, where n=1, 2, 3, 4, or 5, in accordance with one embodiment. As shown in graph 700, the cost impact with n>1 is very low. This is because it is highly unlikely that all the project team members will take unplanned leaves with more than 1 day.

FIG. 8 illustrates a graph 800 of variation of cost impact with the log of probability, of taking exactly n unplanned leaves, where n=1, 2, 3, 4, or 5, in accordance with one embodiment.

As disclosed, embodiments comprise a system that determines the impact of unplanned leaves of project team members on project cost and displays a graphical representation of the cost impact of such unplanned leaves to facilitate the selection of individual team members and/or project teams.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to manage the impact of unplanned leaves on a project, the managing comprising:
receiving historical unplanned leave data corresponding to one or more project team members;
determining, for each of the one or more project team members, a mean time between unplanned leaves and a rate of unplanned leaves based on the member's corresponding historical unplanned leave data;
predicting a cost impact of future unplanned leaves of the one or more project team members, based on at least one of the mean time between unplanned leaves or the rate of unplanned leaves; and
selecting one or more of the one or more project team members to staff the project with the selected members based, at least in part, on at least one of: the determined mean time between unplanned leaves; the determined rate of unplanned leaves; or the predicted cost impact.

2. The computer readable medium of claim 1, the managing further comprising:
displaying a graph to a user, the graph comprising a line graph of the predicted cost impact.

3. The computer readable medium of claim 1, wherein the selecting is performed automatically based on the predicted cost impact.

4. The computer readable medium of claim 1, wherein the selecting is responsive to a manual user selection.

5. The computer readable medium of claim 1, the managing further comprising:
recommending, based on the predicted cost impact, one or more of the one or more project team members to staff the project.

6. The computer readable medium of claim 1, wherein the one or more project team members comprise two prospective project teams, and the selecting includes selecting one of the prospective project teams to staff the project.

7. A computer-implemented method for managing the impact of unplanned leaves on a project, the computer-implemented method comprising:
receiving historical unplanned leave data corresponding to one or more project team members;
determining, for each of the one or more project team members, a mean time between unplanned leaves and a rate of unplanned leaves based on the member's corresponding historical unplanned leave data;
predicting a cost impact of future unplanned leaves of the one or more project team members, based on at least one of the mean time between unplanned leaves or the rate of unplanned leaves; and
selecting one or more of the one or more project team members to staff the project with the selected members based, at least in part, on at least one of: the determined mean time between unplanned leaves; the determined rate of unplanned leaves; or the predicted cost impact.

8. The computer-implemented method of claim 7, the managing further comprising:
displaying a graph to a user, the graph comprising a line graph of the predicted cost impact.

9. The computer-implemented method of claim 7, wherein the selecting is performed automatically based on the predicted cost impact.

10. The computer-implemented method of claim 7, wherein the selecting is responsive to a manual user selection.

11. The computer-implemented method of claim 7, the managing further comprising:
recommending, based on the predicted cost impact, one or more of the one or more project team members to staff the project.

12. The computer-implemented method of claim 7, wherein the one or more project team members comprise two prospective project teams, and the selecting includes selecting one of the prospective project teams to staff the project.

13. The computer-implemented method of claim 12, the managing further comprising:
displaying a graph to a user, the graph comprising a line graph having a line for each prospective project team, each line representing the predicted cost impact for the corresponding prospective project team.

14. A system comprising:
a memory device configured to store an unplanned leave manager module;
a processing device in communication with the memory device, the processing device configured to execute the unplanned leave manager module stored in the memory device to manage the impact of unplanned leaves on a project, the managing comprising:
receiving historical unplanned leave data corresponding to one or more project team members;
determining, for each of the one or more project team members, a mean time between unplanned leaves and a rate of unplanned leaves based on the member's corresponding historical unplanned leave data;
predicting a cost impact of future unplanned leaves of the one or more project team members, based on at least one of the mean time between unplanned leaves or the rate of unplanned leaves; and
selecting one or more of the one or more project team members to staff the project with the selected members based, at least in part, on at least one of: the determined mean time between unplanned leaves; the determined rate of unplanned leaves; or the predicted cost impact.

15. The system of claim 14, the managing further comprising:
displaying a graph to a user, the graph comprising a line graph of the predicted cost impact.

16. The system of claim 14, wherein the selecting is performed automatically based on the predicted cost impact.

17. The system of claim 14, wherein the selecting is responsive to a manual user selection.

18. The system of claim 14, the managing further comprising:
recommending, based on the predicted cost impact, one or more of the one or more project team members to staff the project.

19. The system of claim 14, wherein the one or more project team members comprise two prospective project teams, and the selecting includes selecting one of the prospective project teams to staff the project.

20. The system of claim 19, the managing further comprising:
displaying a graph to a user, the graph comprising a line graph having a line for each prospective project team, each line representing the predicted cost impact for the corresponding prospective project team.
